(19) United States
(12) Patent Application Publication
(10) Pub. No.: US 2019/0007230 A1
(43) Pub. Date: Jan. 3, 2019

(54) APPLIANCE AND METHOD FOR PROCESSING A PLURALITY OF HIGH RESOLUTION MULTIMEDIAL OPERATIVE FUNCTIONS AND PROGRAMS, WHICH APPLIANCE IS INTEGRATED WITH A TELEVISION RECEIVER SCREEN, AS WELL AS REMOTE CONTROL SYSTEM AND REMOTE CONTROL DEVICE AND METHOD TO SET AND DISPLAY SUCH MULTIMEDIAL OPERATIVE FUNCTIONS AND PROGRAMS ON TO THE SCREEN OF SUCH AN APPLIANCE

(71) Applicant: Claudio NORI, Roveredo in Piano (IT)

(72) Inventor: Claudio NORI, Roveredo in Piano (IT)

(21) Appl. No.: 16/121,880

(22) Filed: Sep. 5, 2018

Related U.S. Application Data
(63) Continuation of application No. 11/922,362, filed on Jan. 10, 2008.

(30) Foreign Application Priority Data
Jun. 15, 2005 (IT) PN2005A000038
Sep. 13, 2005 (IT) PN2005A000064
Feb. 21, 2006 (IT) PN2006A000014

(51) Int. Cl. H04L 12/28; H04N 21/47; H04N 21/436; H04N 21/4143; H04N 21/41; H04N 5/44

(52) U.S. Cl. CPC H04L 12/2803; H04N 21/47; H04N 21/43615; H04N 21/4143; H04N 21/4135; H04N 21/4131; H04N 21/4122; H04N 5/44; H04L 2012/285; H04L 2012/2849; H04L 12/2816

(57) ABSTRACT

System and method for processing a plurality of high resolution multimedial operative programs and functions, wherein the system includes a television receiver screen and electronic circuitry, and is adapted to permit to set and display such operative programs and functions on to the television screen. The system also includes main electronic control means, video signal processing means, audio signal processing means, input selector means for analog and digital video and audio signals of any kind, and first, second and third electronic control means for data for personal computers and television receivers, wherein the main electronic control means are adapted to control and manage the data exchange among them and the control means of the system and the external electronic appliances and/or systems, for displaying the images and reproducing the sounds. Furthermore, there are described a remote control system and a remote control device and a method for setting and displaying such multimedial operative programs and functions on to the television receiver screen.

### CROSS-REFERENCE TO RELATED APPLICATIONS

This is a Continuation application of a non-provisional application having an application Ser. No. 11/922,362 filed on Jan. 10, 2008, and a National Stage application of International Registration PCT/IB2006/001688 filed on May 31, 2006, which claims priority to Italian Application Nos. PN2006A000014 filed on Feb. 21, 2006, PN2005A000064 filed on Sep. 13, 2005, and PN2005A000038 filed on Jun. 15, 2005, the contents of which are all incorporated herein by reference.

The invention relates to a system including electronic circuits integrated with a television receiver screen and a method for processing a plurality of high resolution multimedial operative functions and programs of various kind, adapted to permit to set and display such multimedial operative functions and programs on to the television receiver screen. The invention also relates to a remote control system and a remote control device and a method to set and display such multimedial operative programs and functions on to the television receiver screen.

Data processors such as personal computers and the like are known, and operate with determinate operative systems in order to set operative programs and functions of various kind for the more disparate uses, such data processors comprising a processing unit to control and manage data, which is connected operatively with at least one keyboard to set data relating to the desired operative programs and functions and with a screen to display such operative programs and functions.

Television receivers provided with suitable electronic circuits to receive and select programs of various kind are known, which programs are radio transmitted from transmission stations, through possible satellites, or which are transmitted through wire (optic fibers, wires, cables etc.), and are also provided with a high resolution screen of different types (LCD screen, plasma screen etc.), the size of which is larger than that of the personal computer screens, so as to display one or more transmitted programs or any possible properly selected additional functions, such as for example teletext etc.

The object of the present invention is to provide for a system including electronic circuits integrated with a television receiver screen and a method for processing multimedial operative programs and functions, adapted to permit to set, process and manage through electronic controls all the multimedial operative programs and functions and to display these operative programs and functions on to the television receiver screen.

The invention also relates to a remote control system for combined systems of this kind, adapted to permit to control the television screen switching on and off and the operation of a plurality of outer peripheral appliances which are operatively connected with these combined systems, as well as to control the carrying out of a series of functions of the same systems. Finally, the invention relates to a remote control device and a method for a system of this type, adapted to set and allow to perform a plurality of high resolution multimedial operative programs and functions on the same system.

The above mentioned processing system and method, the remote control system and the remote control device and method are made with the characteristics and in the manners substantially described, with particular reference to the attached claims. The invention will be better understood from the following description, given solely by way of not-limiting example and with reference to the following accompanying drawings in which

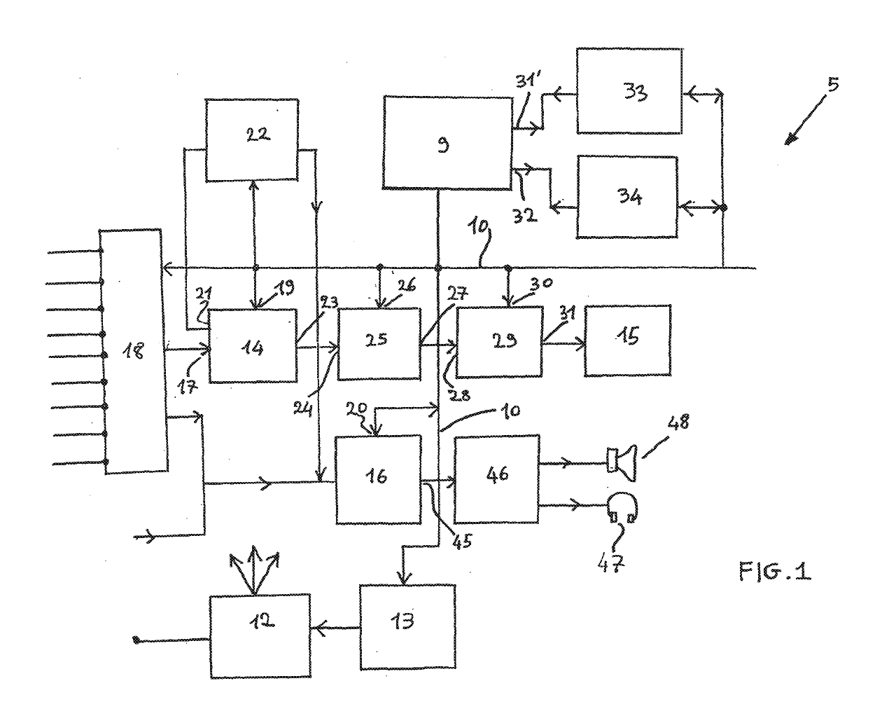

FIG. 1 shows an electric block diagram of a part of the system according to the invention, incorporating the electronic control and management circuits for data of operative programs and functions of various kind, which are set and displayed on the television receiver screen of the system;

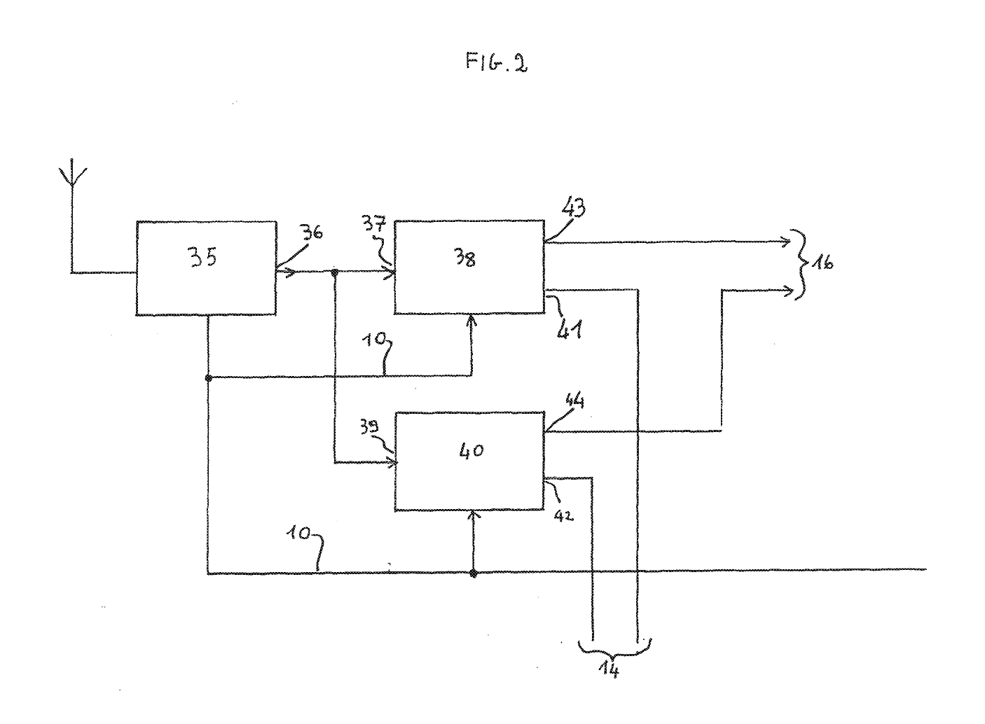

FIG. 2 shows an electric block diagram of a circuit part of the control circuit of FIG. 1;

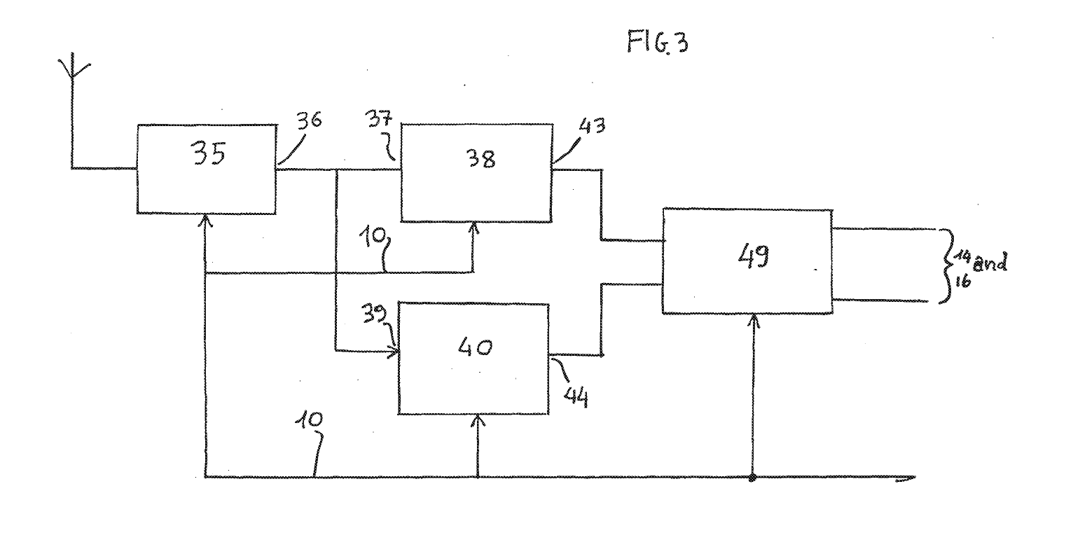

FIG. 3 shows an electric block diagram of a constructive version of the control circuit of FIG. 2;

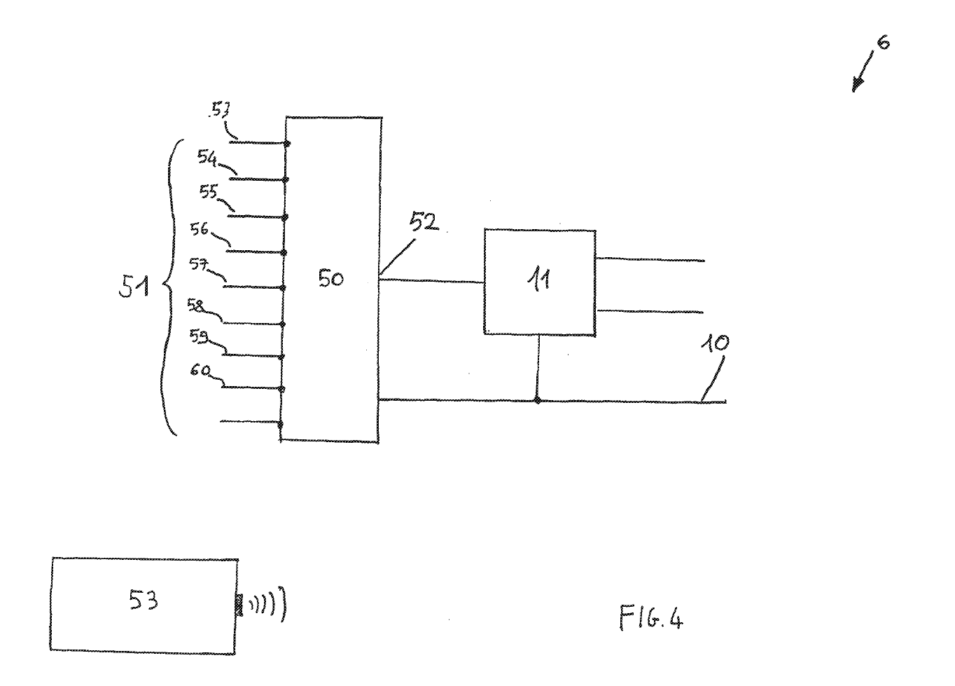

FIG. 4 shows an electric block diagram of a remote control circuit for input and output data of the system according to the invention;

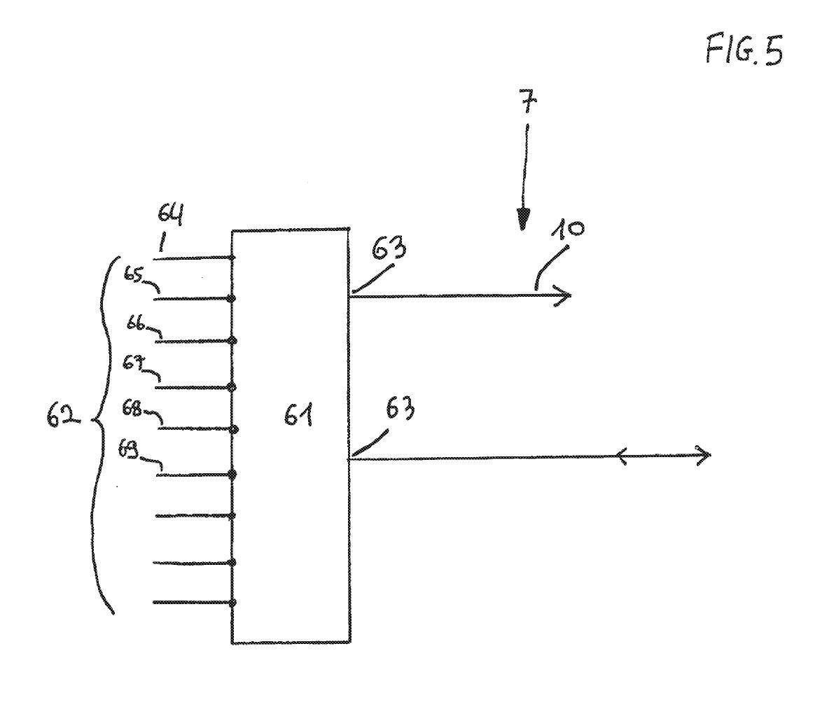

FIG. 5 shows an electric block diagram of a control circuit, with or without wires and cables, for input and output audio data of the system;

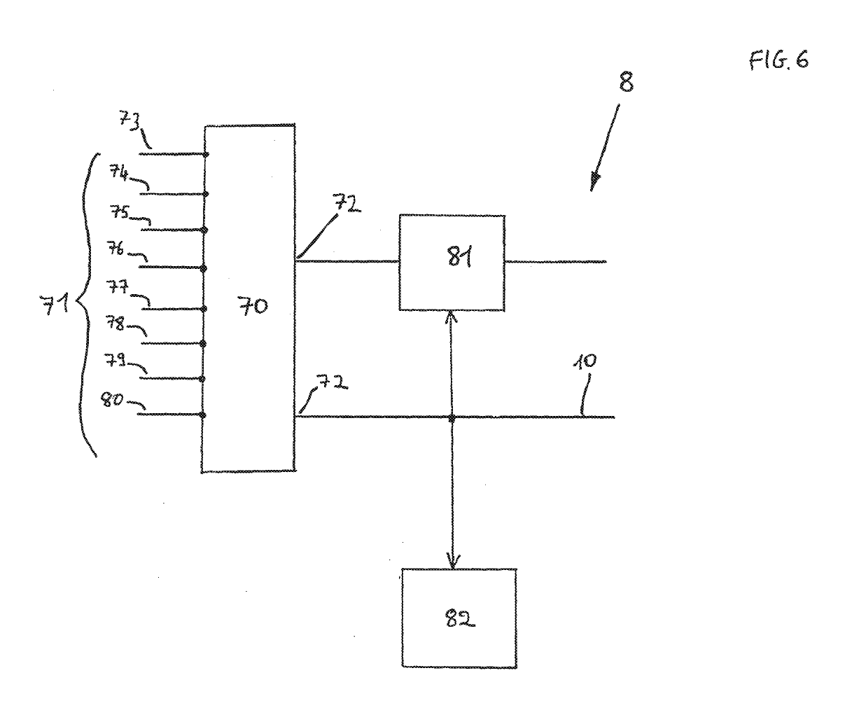

FIG. 6 shows an electric block diagram of a control circuit, with or without wires and cables, for input and output data of various kind of the system according to the invention;

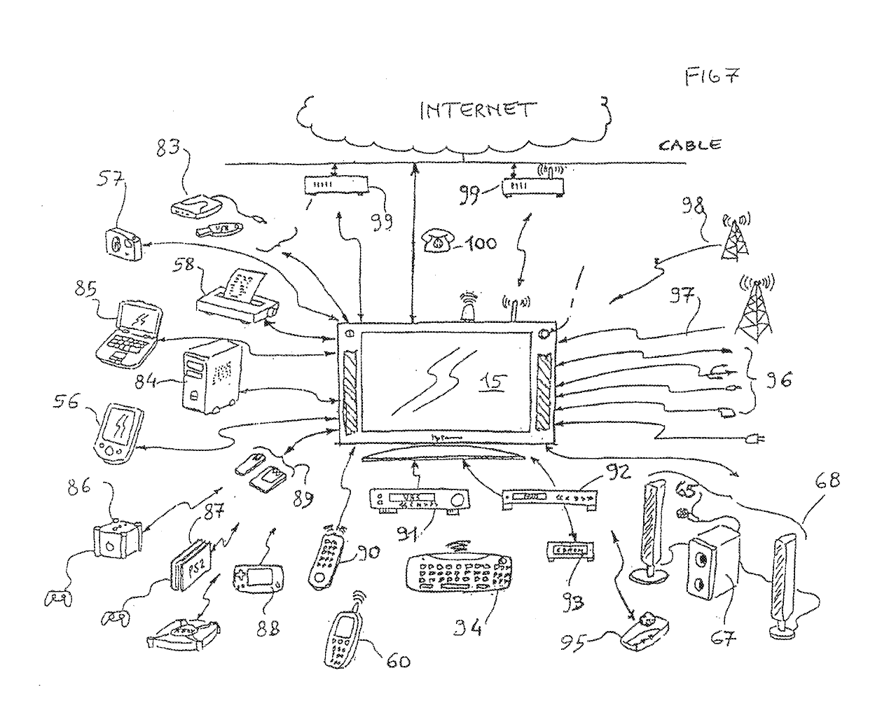

FIG. 7 shows a principle schema of some peripheral appliances which may be operatively incorporated and/or connected and used with the present system;

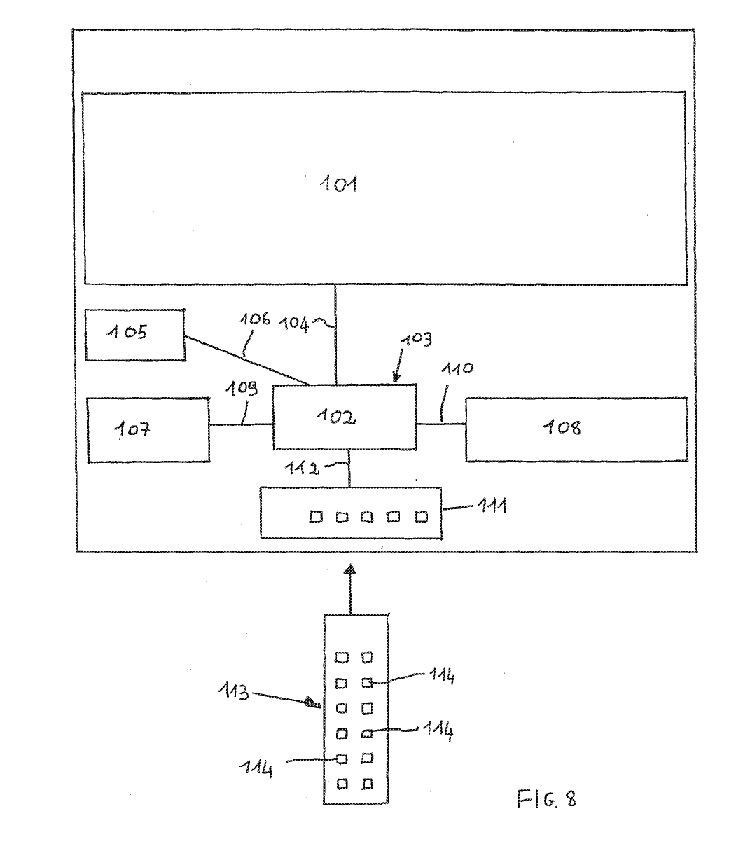

FIG. 8 shows an electric block diagram of the different components of the remote control system according to the invention;

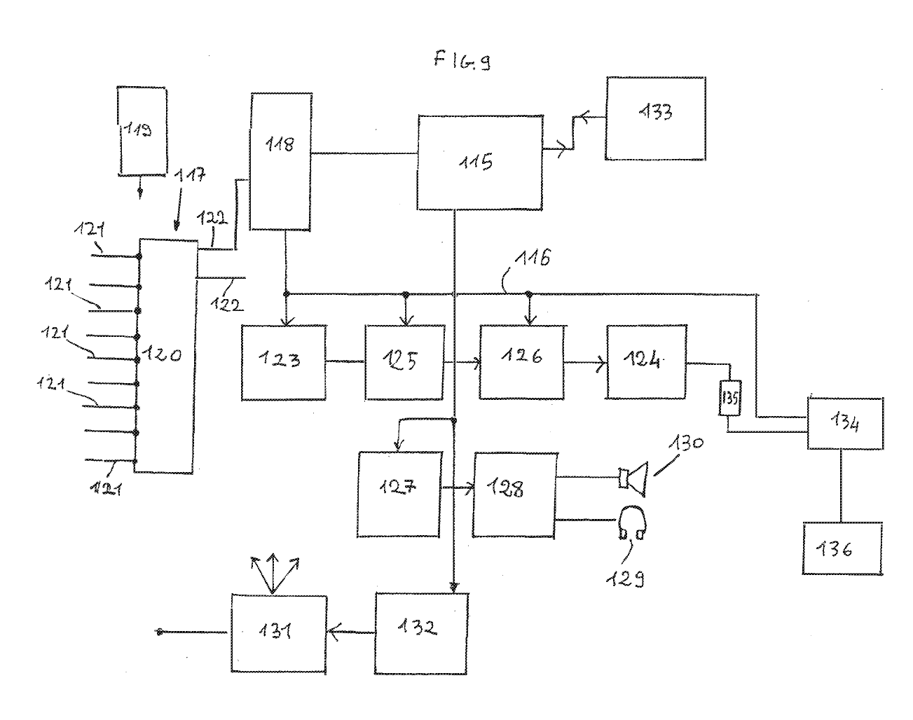

FIG. 9 shows an electric block diagram of the electronic control circuit of the above described processing system, adapted to be controlled and managed by the remote control device according to the present invention.

FIGS. 1-7 represent some electric block diagrams of the different electronic circuits included in the present invention, for processing a plurality of high resolution multimedial operative programs and functions of various kind, which is integrated with a television receiver screen, the size of which is preferably of at least 26″ and the resolution of which is preferably of at least 1280×720 pixels, in order to set, process, manage and display on to the same screen such operative programs and functions.

In particular, the block diagrams of such electronic circuits are shown in FIGS. 1-6, the FIG. 1 of which shows the control and management circuits 5 of data of the operative programs and functions which are set and displayed on the television receiver screen, the FIG. 2 of which shows a circuit part of the control circuit of FIG. 1, the FIG. 3 of which shows a constructive version of the control circuit of FIG. 2, the FIG. 4 of which shows a remote control circuit 6, for example of the infrared type for input and output data of the system, the FIG. 5 of which shows a control circuit with or without wires, cables and optic fibers 7 for input and output data of the system, and the FIG. 6 of which shows a control circuit with or without wires, cables and optic fibers 8 for input and output data of various kind of the system.

With reference to FIG. 1, it is noted that the control circuits comprise substantially at least a master or main microprocessor 9 of conventional type, generally provided with a passive type of cooling (without fans), for eliminating noises, controlling and managing informatics digital and analog data in general and the operative programs and functions for personal computers and television receivers of various kind, which is connected operatively with any electronic circuit for selecting and setting such digital and analog data, with or without wires, cables and optic fibers, both included directly into the present system and connected temporarily or permanently with the same system, and/or which is included in electronic appliances or systems which are external to the system, which are connected temporarily or permanently with the system. In particular, this master microprocessor 9 is set in advance in a manner to input these digital and analog data, for managing and processing the same data, and for transmitting corresponding response output data adapted to control the carrying out of the set operative programs and functions, through the present system and the possible external electronic appliances or systems, by displaying the relative images and the relative sounds in the corresponding video and audio electronic circuits associated with the television screen, or also with screens of external electronic appliances or systems in case connected operatively with the present system. The master microprocessor 9 is also set in advance for processing and managing digital and analog data inputted from external electronic appliances and systems, connected temporarily or permanently with the present system and provided with corresponding selecting and setting electronic circuits of such data, relative to informatics data in general and data of operative programs and functions for personal computers and television receivers, in order to transmit as output the so processed and managed response data toward the present system and toward possible further external electronic appliances and systems connected temporarily or permanently with the same.

Finally, the master microprocessor 9 is also set for controlling and checking the correct operation and the carrying out of the operative programs and functions for personal computers and television receivers of the present system and the external electronic appliances and systems, and for signalling and in case correcting automatically any not correct operation or for signalling also possible operative failures or defects of the different electronic circuits employed. By way of not limiting example only, a master microprocessor which can be used is advantageously a model Pentium M 770 2.13 GigaHz of Intel, but of course also microprocessors of different manufacturers provided with large storage capacity memory may be used. Such master microprocessor 9 is connected with a BUS control line 10 to both the remote control circuit 6, through a multiplexer switch 11, and the control circuit 7 and the control circuit 8. The master microprocessor 9 is also provided with further linkages, which will be described later. In turn, the control and management circuits 5 also comprise a supply unit 12 generally provided with cooling devices of passive type (without fans), for eliminating noise, which is connected to the a.c. main voltage input and is adapted to generate a low d.c. voltage at its output, so as to supply all the electronic circuits, such supply unit being also connected to a management circuit 13 for supplying partially or fully the different electronic circuits; a video processor 14 connected to both the master microprocessor 9 and the television screen 15 of the present invention, in order to receive and process video signals of any kind depending on the informatics data and the operative programs and functions respectively set and processed through such master microprocessor 9, and to display such video signals on to the video screen 15; and an audio processor 16 connected to the master microprocessor 9 and the sound reproduction transducers, for processing and reproducing the audio signals depending on the informatics data and the operative programs and functions respectively set and processed through such master microprocessor 9.

In particular, the video processor 14 is provided with a set of inputs and a set of outputs, a first input 17 of which connected to an input selector of analog and digital video and audio signals 18, in order to receive and introduce such video and audio signals and to decode only the video signals therefrom, so as to convert them into signals compatible with the operation of the television receiver screen, and to be introduced into the video processor 14, and in the example shown therein the video and audio signals received from such selector 18 are constituted by CVBS standard video signals, by S-VHS signals, by Y Pb Pr signals, by RGB color video signals, by DVI signals, by HDMI signals, by VGA signals, by USB signals, and by TEE 1394 signals, and of course also by other kind of signals. Therefore, these video and audio signals may be constituted by radio signals transmitted from suitable external transmitting stations and/or by signals transmitted through cables, wires and optic fibers connected to audio and video appliances and audio and video recording and reproducing appliances of various kind, and to the signal selector 18. A second input 19 of the video processor 14 is connected to the master microprocessor 9 through the BUS control line 10, which in turn is connected to both the input selector 18 and to an input 20 of the audio processor 16. A third input 21 of the video processor 14 is also connected to a possible television camera 22 for transmitting video conference remote images or other kind of images. In turn, the output 23 of the video processor 14 is connected to a first input 24 of a graphic unit 25 for processing video signals, which in the present example is constituted by a microchip Intel 915, but which may be constituted of course also by integrated circuits of other kind, said graphic unit 25 being connected with its second input 26 to the master microprocessor 9, through the BUS control line 10, and with its output 27 to a first input 28 of a possible driver adapter 29, the second input 30 of which is connected to the master microprocessor 9 through the BUS control line 10. In turn, the possible driver adapter 29 is connected with its output 31 to the video screen 15, and permits to drive this latter with a high resolution signal and a single or double channel. In this manner, the video processor 14 may receive video signals of different kind, through the input selector 18, and provides for processing such video signals, through the master microprocessor 9 and depending on the informatics data and the operative programs and functions for personal computer and television receivers which have been selected and set, by generating an output signal (for example, a signal of type ITU 656) for the operation of the graphic unit 25, and in turn the possible driver adapter 29 which is controlled by such graphic unit 25 generates a driving signal (for example, a signal of type LVDS, namely a low voltage differential signal) for the video screen 15, with consequent display of the relative video images on to the same screen. Such video screen 15 may be of any kind existing on the market (LED, plasma, LCD. etc.). Finally, the master microprocessor 9 is also connected with its outputs 31′ and 32 respectively to a mass storage unit 33 (hard disk) and a writing/reading optical device 34 of conventional type, which in turn are connected to the BUS control line 10. The FIG. 2 shows also by way of example a first manner for obtaining video and audio signals which are used for controlling and driving the video screen 15 and the sound transducers. Then, in this case the relative audio and video signals which are radio transmitted are both received by a tuner 35 for analog and digital television, the output 36 of which is connected to both an input 37 of an analog demodulator 38 and an input 39 of a digital demodulator 40, wherein the first output 41 of the analog demodulator 38, which generates a type of video signal, is connected to the video processor 14, and wherein the first output 42 of the digital demodulator 40, which generates another type of digital video signal, is also connected to the video processor 14, in a way that the video signals so received from such video processor are processed by the same for driving subsequently the video screen 15 as previously described. Moreover, such demodulators 38 and 40 generate at their respective second outputs 43 and 44 a corresponding audio signal, which is transmitted to the audio processor 16 for being subsequently reproduced. In turn, such audio processor 16 (see FIG. 1) is connected with its output 45, through a sound amplifier 46, to the sound reproducing transducers which in the example here represented are constituted by audio domes 47 and loudspeakers 48. Finally, the tuner 35 and the analog demodulator 38 and digital demodulator 40 are connected to the master microprocessor 9 through the BUS control line 10 (see Fig. T). FIG. 3 describes now a second manner for using audio and video signals, which are always obtained through the tuner 35 and the analog demodulator 38 and digital demodulator 40, as previously. Then, in this case the video and audio signals coming from the respective demodulators 38 and 40, instead of being addressed to the video and audio processors as previously, are let to pass through. an encoder/decoder 49 connected to the output of both the demodulators 38 and 40, and to the BUS control line 10, which changes them into flows of video and audio data independent from each other, which are then transmitted to the respective video processor 14 and audio processor 16, for performing the same above described functions. FIG. 4 represents the remote control circuit 6, for example of the infrared type, which is situated. near the present system and provided for effecting an informatics data exchange at the input and output with respect to the same system. This means that such remote control circuit may introduce into the appliance some informatics data which have been set in advance on external peripheral appliances, interacting with the same remote control circuit, for displaying the images and reproducing the sounds contained into such data, and may receive from the present system some informatics data to be transmitted to such peripheral appliances for displaying the images and reproducing the sounds contained into the same data. Furthermore, such remote control circuit 6 permits to set and select directly into the peripheral appliances the operative programs and functions for personal computers and television receivers, and for controlling functions of the more different kinds, to be performed in the present invention. As examples of programs and functions to be carried out there can be cited, in addition to the typical ones for these appliances, also the operation controls for household appliances of various kind, domotics controls (light switching on and off, door and gate driving mechanisms, controls of various kind for gardening appliances, surveying appliances, for videogames, for video gambling appliances etc.), for printing machines, portable computers, for Internet network and electronic and/or informatics appliances of various kind, the programs set in advance purposely for appliances such as portable phone apparatuses, palmar apparatuses, which therefore may perform the function of remote control devices. This remote control circuit is substantially constituted by a receiver/detector 50 adapted to receive and decode some informatics data introduced through radio and cable, wire and optic fibers systems, or infrared systems, through a plurality of inputs 51, and to transmit them to the master microprocessor 9 through one or more outputs 52 of such receiver/detector, which are connected to the master microprocessor 9 through the multiplexer switch 11 and the BUS control line 10. Such inputs 51 may be connected operatively with appliances of various kind, which in the described example are constituted by remote controls 53, by keyboards and mouses 54 for personal computers, by appliances 55 connected to the internee network, by manual operated instruments 56 (palmar appliances) of various kind, by digital cameras 57, by printing machines 58, by portable computers 59 for setting data of various kind, by portable phones 60, and the like. In this way, the informatics data of various kind and the data of the programs and functions contained into said appliances and/or which are set with the same and introduced into the receiver/detector 50, are transmitted from this latter, through the multiplexer switch 11, to the master microprocessor 9 which provides for processing them and conveying the video signals through the video processor 14, which displays them with the described criteria on to the video screen 15, and the audio signals through the audio processor 16 which permits the reproduction through the sound transducers 47 and 48 thereof. By referring now to FIG. 5, showing the control circuit 7 for setting and selecting inputted and outputted audio data of operative programs and functions for personal computers and television receivers, it is noted that it is constituted substantially by at least a multiplexer switch 61 adapted to re-distribute the inputted and outputted audio data, which are received and transmitted with or without cables, wires and optic fibers through a plurality of inputs/outputs 62 of the same switch, and to convey them. toward the audio processor 16 or to receive them from the same processor, through one or more outputs/inputs 63 of such a switch, which are connected to the master microprocessor 9 through the BUS control line 10. Some audio appliances of various kind can be connected to such inputs/outputs 62, which in the described example are constituted by digital inputs/outputs 64 for television systems, by microphones 65, by sound reproducing apparatuses 66 for the introduced sounds, and by central-subwoofer loudspeakers 67, by audio systems 5.1 and 7.1 68 for the transmitted sounds, and by SPDIF data systems 69, and the like. In this way, the audio data of the programs and functions introduced or transmitted through such audio appliances or with different systems are conveyed from the master microprocessor 9 to the audio processor 16, which reproduces them with the described criteria into the transducers 47 and 48 and the same audio appliances. By referring now to the FIG. 6 showing the control circuit 8 for informatics data in general and for inputted and outputted video and audio data of the present system, it is noted that it is substantially constituted by at least an access gateway 70 adapted to receive and transmit with or without cables, wires and optic fibers some informatics data of various kind and video and audio data of operative programs and functions for personal computers and television receivers, and provided with a set of inputs/outputs 71 for connecting a plurality of peripheral appliances of various kind, and one or more outputs/inputs 72 connected through the BUS control line 10 to the master microprocessor 9. Such access gateway 70 may receive through said peripheral appliances the informatics data in general and the inputted video and audio data of the programs and functions contained or set into the same appliances, and may also transmit toward such peripheral appliances such informatics data and the video and audio data of the programs and functions which have been set through the video control circuit 6 and the audio control circuit 7 of the present invention.

In the described example, the peripheral appliances are constituted by telephonic lines 73, by data lines 74, by internet appliances 75, all inputted and outputted operated, and by manual instruments 76 (palmar appliances), by movable phones 77, by optic fibers 78, by telephonic pairs 79, all inputted and outputted operated, and finally such appliances may be constituted also by at least a through radio or telephone, cable, wire and infrared radiation receiving and transmitting system 80, adapted to receive from outer uses the informatics data in general and the video and audio data of the programs and functions set on to these outer uses, for displaying the received images and reproducing the received sounds respectively into the video screen 15 and the sound transducers 47 and 48 of the present invention, said receiving-transmitting system 80 being also adapted to transmit toward such outer uses the informatics data in general and the video and audio data of the programs and functions set through the control circuits 6 and 7 of the present invention, and the images and sounds of which may be in case displayed and reproduced in the same television receiver screen. Also such peripheral appliances permit to control the carrying out of programs, functions and controls like those described with reference to the FIG. 4. Finally, the master microprocessor 9 of the present system is also set for performing additional programs and functions of various kind, and by way of example only it may be connected to electronic readers 81 of cards containing data of any kind (bancomat, various documents, administrative matters etc.), to identifying systems 82 of any object for example of supermarket wares, warehouses, card operated electronic locks etc.), to wireless receiving-transmitting systems or systems without cables and optic fibers, and other suitable electronic means containing informative data of the more different kinds, and this in order doing electronic data exchanges between the master microprocessor 9 and these peripheral appliances or circuits, and to display the images and in case to reproduce the sounds contained into such peripheral appliances in the television receiver screen.

All the informatics data in general and the audio and video data of the various programs and functions for personal computers and television receivers and controls are received and transmitted with a large band and high speed, preferably ranging from 10 megabit/sec, and over, and permit to obtain high resolution images and sounds in the present invention and the external appliances and systems interacting with the present invention. Therefore, this invention allows to manage on a single position all the linkages with appliances of various kind, separated or combined to each other, which until now were managed separately by specific managers.

Finally, FIG. 7 shows a principle schema of some peripheral appliances, which may be external ones and connected to the present system, or they may be included directly in the present system, and which are interacting with the video screen and the audio system of the present system. As examples of such peripheral appliances there are noted, in addition to those already described previously, also a data storage of data of various kind 83, of removable type, a personal computer 84, a portable computer 85, videogames appliances 86, 87 and 88, storage cards 89, a remote control apparatus 90, an audio and/or video recorder 91, and a DVD apparatus 92, which may be already included into the present system, a CD/DVD recorder 93, a phone-keyboard combined apparatus 94, a MP3 apparatus 95, some sockets 96 of various kind (video, scart, USB) 5 an antenna cable 97, a receiving-transmitting radio 98, some modems with or without wires, cable etc. 99, a phone 100 for internet connection etc., also included into the present system. The present invention also relates to a method for processing informatics data in general and a plurality of multimedial operative programs and functions, which is used for the operation of the above described system for processing such multimedial operative programs and functions. This processing method consists in that some informatics data in general and analog and digital data of multimedial operative programs and functions are introduced via radio, cable and optic fibers into the master microprocessor 9, which programs and functions are set and selected directly into the system processor according to the invention, through said first, second and third electronic control means (6, 7, 8), together with said in selector means (18) for receiving video and audio signals of various kind, and into corresponding control means for electronic appliances and/or systems connected operatively to such master microprocessor 9, and that such master microprocessor 9 is set for managing and processing the same data and for transmitting corresponding response output data adapted to control the carrying out of the operative programs and functions which have been set, and said video signal processing means (14) and audio signal processing means (16) and the external electronic appliances and/or systems, by displaying the corresponding images and reproducing the corresponding sounds into the relative television screens (15) and sound transducers (17, 48) of the present system and the external electronic appliances and/or systems. This processing method permits also to control and verify the correct operation and carrying out of the operative programs and functions according to the invention and the external electronic appliances and systems, for signalling and in case correcting automatically any possible not correct operation, or for signalling also any operative failure or defect of the present system and the external electronic appliances and systems. Besides, one or more images of different programs of the present invention and the peripheral appliances connected operatively thereto may be displayed on to the screen. This processing method permits to set and select, through said first, second and third control means (6, 7, 8), together with said input selector means (18), and into corresponding control means for external electronic appliances and/or systems connected operatively to the master microprocessor (9), some informatics data of a plurality of operative programs and functions which are typical for personal computers and television receivers of various kind, the images of which are displayed and the sounds of which are reproduced, and of the function controls of the more different kinds such as for instance remote controls, controls for household appliances, domotics controls, videogame controls, in order to interact with controls, games, services and other functions available from the Internet network, for example video and/or audio services on request, services for hotels, cruise vessels, teleuniversities, state boards, managing and processing multimedial services for communities, etc., programs for appliances like portable phones, printers, portable computers, electronic and/or informatics appliances of various kind, on-line reading of newspapers, magazines etc., with possibility to file, register, reproduce and create contemporaneously some informatics data of any kind.

With reference to the FIG. 8, it is now described a remote control system for a plurality of operative functions and multimedial programs, adapted to control a system according to the present invention, in order to set and display such operative programs and functions on to the television screen thereof and to manage the operation of the circuit components of said invention, and adapted to permit to control the switching on and off of the television screen and the operation of a plurality of external peripheral appliances connected operatively to these combined devices, as well. as to control the carrying out of a set of functions for the same devices. Said FIG. 8 illustrates schematically the electric circuit diagram of the different components of the remote control system according to the invention, which is used combined with the system of the present invention, which is substantially constituted. by electronic main control means, in the form of a master microprocessor 101 of conventional type, connected to the same means described on FIG. 1. The present remote control system comprises substantially at least a microprocessor 102, included into an electronic control card 103 which is included in the system of the present invention, separately from the remaining electronic circuits of the system, and this microprocessor is connected operatively to the master microprocessor 101, through a serial data line 104, to the electric power supply 105, through a line 106, to at least an audio amplifier 107 and the television screen 108, through respective lines 109 and 110, and to a conventional infrared radiation receiver 111, which is also included into the present invention, through a line 112, which receiver is controlled by a conventional external infrared radiation remote control apparatus 113, provided with selection keys 114 which can be actuated by the user for selecting the operative functions and the multimedial programs to be carried out in the present invention. In particular, the data of the programs and functions which have been selected through the keys 114 of the infrared operated remote control 113 are transmitted to the receiver 111, which in turn transmits them to the microprocessor 102, and depending on the inputted data received such microprocessor 102 provides for controlling directly the peripheral appliances connected thereto, for performing the selected operative programs and functions, or provides for processing corresponding response data which are transmitted to the master microprocessor 101, through the serial data line 104, and in turn such master microprocessor provides for controlling the carrying out of the respectively set programs and functions.

The microprocessor 102 is set for decoding and recognizing the inputted data which have been set in the external remote control 113 and transmitted through the infrared receiver 111, and in response to the received data it provides for controlling and managing the peripheral appliances connected thereto, in this case the sound amplifier 107, the television screen 108, which in this case is a LCD screen, and the electric power supply 105, but this microprocessor 102 could also control and manage possible additional peripheral appliances connected thereto. Moreover, such microprocessor 102 may also control the electric power supply 105 for switching on or off the master microprocessor 101, and the present entire system, and permits also doing an informative data exchange between it and the master microprocessor 101, through the serial data line 104. Thus, the present system permits to set, through the infrared remote control 113, data of all the operative programs and functions to be performed in the inventive system, through both the microprocessor 102 and the master microprocessor 101. Then, in the first case it is possible to control the operation of the loudspeakers connected to the sound amplifier 107, for performing “muting” operations namely lowering or annulment of the sound volume, and “sleep” operations namely consumption reduction. Moreover, through such microprocessor 102 it is also possible switching on and off the sound amplifier 107, and to generate a train of “power on” and “power off’ periodic signals for switching on and off the television screen 108, which condition is required in that the circuit components of such screen need an exact sequence of switching on and off for an effective and correct operation of the same screen.

Such microprocessor 102 also permits to control and adjust the brilliance of the luminous spots of the television screen 108, and therefore also the brilliance of the same screen.

Moreover, the control by the microprocessor 102 of the electric power supply 105 may also manage a low energetic consumption appliance operation, even when the master microprocessor 101 is switched off or is on standby state, and anyway is inactive, and under such circumstances the microprocessor 102 is able to control and manage autonomously the operation of the peripheral appliances connected thereto. Furthermore, the microprocessor 102 is also set for controlling the operative states of the master microprocessor 101 (switched on or off, standby etc.) and for producing corresponding response signals to the remote control 113, adapted to signal such operative states to the user. Such microprocessor 102 my be also set for storing a plurality of data of additional programs and functions of various kind to be carried out in the present appliance or the peripheral appliances, and in the internet network or other external appliances connected to the present system, which data may be controlled and managed by either one of the two microprocessors 101 or 102. In the case in which the operative programs and functions which have been set through the infrared remote control 113 and transmitted to the master microprocessor 101 are controlled and managed by such master microprocessor 101, the present remote control system is able to interact with such master microprocessor, for exchanging the inputted and outputted informative data therewith, so as to control the present system and the peripheral appliances, the internet network and other possible external appliances through this master microprocessor 101, or also through the other microprocessor 102, and for transmitting corresponding response signals to the same remote control, for signalling the state of the programs and functions which have been set.

The so realized remote control system permits to interact with the present processing system, in order to be able to use easily and quickly the same. Moreover, it allows to replace the conventional input selector means (keyboards, mouses, etc.), in a way to simplify and centralize the operation management of such a system and to make available an autonomous and original means for selecting the operative programs and functions, permitting to manage also complex electronic circuits which wouldn't be managed easily through standard operative systems.

With reference to FIG. 9, it is now described a remote control device associated with a system of the kind referred to, which is adapted to set and permit the carrying out of a plurality of high resolution multimedial operative programs and functions in the same systems. The electronic control circuit of the system is substantially constituted by said master or main microprocessor 115 of conventional type, which is connected through a BUS control line 116 to a remote control circuit 117 for data of the operative programs and functions which are set and displayed on this system, through a multiplexer switch 118. Such remote control circuit 117, which is controlled by means of the remote control device 119 according to the invention, may introduce into the system some informatics data set in advance on external peripheral appliances, interacting with the same remote control circuit, for displaying the images and reproducing the sounds contained into such data, and may receive from the system some informatics data to be transmitted to such peripheral appliances for displaying the images and reproducing the sounds contained into the same data. Besides, the remote control circuit 117 allows to set and select directly on the peripheral appliances the operative programs and functions for personal computers and television receivers, or for controls of functions of the more different kinds, to be performed in this system. As examples of programs and functions to be performed, there may be cited, in addition to those typical for these appliances, also controls for operations of household appliances of various kind, domotics controls (light switching on and off, door and gate actuators, various controls for gardening and watching appliances, controls for videogames, video controlled gambling games etc.), for printers, portable computers, internet network and electronic and/or informatics appliances of various kind, programs set in advance purposely in appliances like portable phones and palmar apparatuses, etc. Such remote control circuit 117 is substantially constituted by a receiver/detector 120 adapted to receive and decode the informatics data introduced by acting on to the present remote control device 119, and for this purpose it is provided with a plurality of data inputs 121, and one or more outputs 122 connected to the master microprocessor 115, through the BUS control line 116 and the multiplexer switch 118, so as to transmit the received informatics data to the master microprocessor.

Moreover, the master microprocessor 115 is connected through the BUS control line 116 to both a video processor 123, which in turn is connected to the screen 124 through a graphic unit. 125 (GUI) for processing video signals and a possible driver adapter 126, and an audio processor 127 which is connected, through a sound amplifier 128, to the sound reproducing transducers, in the example here represented constituted by audio domes 129 and loudspeakers 130. In addition, the ter microprocessor 115 is connected with the BUS control line 116 to both a power supply unit 131, through a managing circuit 132 for the partial or total power supply of the different appliance electronic circuits, and a mass storage unit (hard disk) 133. Moreover, a control circuit 134 is provided and connected to the BUS control line 116 and the inverter 135, which is included into or separated with respect to the screen 124, said control circuit being adapted to control the inverter 135 to drive the screen electric values (switching on and off, brightness, contrast etc.) depending on the electric pulses coming from the remote control device 119, and containing the digital and analog data of the operative programs and functions which have been set into such remote control device and which must be carried out into the inventive system and/or the external electronic appliances and/or systems, and depending on the received data it provides for transmitting corresponding response electric pulses to the remote control circuit 117, through the multiplexer switch 118 and the master microprocessor 115, which latter activates consequently the video processor 123 and audio processor 127 and therefore the operation of the screen 124 and the sound reproducing transducers 129, 130, respectively. Finally, the control circuit 134 is also connected to a video signal card 136, which checks the flow of data processed by the master microprocessor 115 being transmitted to the same control circuit and, depending on the sensed or not sensed data, it provides for warning the control circuit 134 of the operative state thereof.

The present remote control device 119 is of a type identical to those existing in commerce, and therefore is also provided with several control and selection keys for the different operative programs and functions and for displaying the operative conditions of the same remote control device and the operative programs and functions which have been set respectively in the inventive systems and/or the external electronic appliances and/or systems. In turn, the mass storage unit (hard disk) 133 is a reading and writing mass storage for digital and analog informatics data, which is memorized in advance with a plurality of operative programs and functions of various kind which must be from time to time carried out in the inventive systems and/or the external electronic appliances and/or systems. These programs may be for example the Windows, Windows Media Center programs and any other kind of operative program already existing in commerce or also operative programs which might be developed in the future, as well as they may be software of any kind for personal computers and television receivers and for the more disparate applications, for example for controlling the operation of household appliances, medical appliances, photographic appliances, and any application involving the use of electronic circuits with traditional or particular software. Such mass storage unit 133 may be memorized at any time also with additional operative programs and functions of any kind, for carrying out additional programs and functions in the inventive systems and/or the external electronic appliances and/or systems. Likewise, it may be also de-memorized for erasing and/or replacing the operative programs and functions already introduced therein.

All the operative programs and functions which have been memorized in the mass storage unit 133 are coded with specific analog and digital data, and these analog and digital data are also introduced with the same coding in the remote control device 119, in a way that this latter makes it possible to select the operative programs and functions required from time to time, by acting on to the relative remote control selection keys, and by displaying them on to the display of the same remote control. Under these conditions, each time that an operative program and function are selected in the remote control device 119, this latter provides for generating electric pulses coded in. a corresponding manner, which are transmitted to the system master microprocessor 115, thereby memorizing into such master microprocessor the same selected program and function.

Afterwards, when the selected operative program and function are started by acting on to the start key of the remote control device 119, this latter provides for generating corresponding electric pulses which control, through the controller circuit 134, the switching on of the power supply unit 131, the master microprocessor 115 and all the remaining electronic circuits of the system and/or the external electronic appliances and/or systems, and the controller circuit 134 receives from the master microprocessor 115 response electric pulses, which are transmitted from this latter to the remote control device 119, by indicating in the relative pilot lamps of this latter the switched on state of the relative electronic appliance and/or system and the preset state thereof to carry out the set operative program and function. In this way, by acting on to the different remote control device keys, the selected operative program and function are started and contemporaneously there are adjusted all the parameters (brightness, sound intensity etc.) of the operative program and function to be carried out. The present invention also relates to a method for setting and carrying out such multimedial operative programs and functions, used in combination with a remote control device as described above, for permitting the carrying out of these multimedial operative programs and functions into the present system, and/or also into external electronic appliances and/or systems connected operatively to this mass storage unit 133 and the master microprocessor 115, so as to display the images and reproduce the sounds of the operative programs and functions set from time to time and carried out into this system and the external electronic appliances and/or systems. This processing method consists in that the mass storage unit (hard disk) 133 is memorized in advance or afterwards with a plurality of operative programs and functions of various kind, to be carried out by the inventive system, and/or the external electronic appliances and/or systems, which programs may be for example the Windows, Windows Media Center programs and any other operative program already existing in commerce or also operative programs which might be developed in the future, as well as they may be software of any kind, for personal computers and television receivers, and for the more disparate applications, for example for controlling the operation of household appliances, medical appliances, photographic appliances and any application involving the use of electronic circuits with traditional or particular software. Such mass storage unit 133 may be memorized at any time also with additional operative programs and functions of any kind, for carrying out additional operative programs and functions into the inventive system and the possible additional external electronic appliances and/or systems.

Besides, it may be also de-memorized for erasing and/or replacing the operative programs and functions already introduced therein. All the operative programs and functions which have been memorized into the mass storage unit 133 are coded with specific analog and digital data, and these analog and digital data are also introduced with the same coding in the remote control device 119, in a way that this latter makes it possible to select the operative programs and functions required by acting on to the relative remote control selection keys, and by displaying them on to the display (s) of the same remote control. Under these conditions, each time that an operative program and function are selected in the remote control device 119, this latter provides for generating electric pulses coded in a corresponding manner, which are transmitted to the system master microprocessor 115, thereby memorizing into such master microprocessor the same selected operative program and function. Afterwards, when the selected operative program and function are started by acting on to the start key of the remote control device 119, this latter provides for generating corresponding electric pulses which control, through the controller circuit 134, the switching on of the power supply unit 131, the master microprocessor 115 and all the remaining electronic circuits of the system and/or the external electronic appliances and/or systems, and the controller circuit 134 receives from the master microprocessor 115 response electric pulses, which are transmitted from this latter to the remote control device 119, by indicating in the relative pilot lamps of this latter the switched on state of the relative electronic appliance and/or system and the preset state thereof to carry out the set operative program and function. In this way, by acting on to the different remote control device keys, the operative program and function are started and contemporaneously there are adjusted all the parameters (brightness, sound intensity, etc.) of the operative program and function to be carried out.

These remote control device and method permit to set and select, into the system and/or the external electronic appliances and/or systems, a plurality of operative programs and functions typical for personal computer and television receivers in general, the images of which are displayed and the sounds of which are reproduced, and of the controls for the functions of the more disparate kinds, such as for example controls for household appliances, domotics controls, videogame controls, for interacting with controls, games, services and other functions available from the internet network, for example video and/or audio services on request, services for hotels, cruise vessels, teleuniversities, state boards, managing and processing multimedial services for communities etc., programs for appliances like portable phones, printers, portable computers, electronic and/or informatics appliances of various kind, on-line reading of newspapers, magazines etc., with possibility to file, register, reproduce and create contemporaneously some informatics data of any kind.

What is claimed is:

1. A system for processing multi-media programs and functions comprising:
a BUS;
at least one main processor configured to be operatively connected to the BUS;
a signal selector configured to communicate with at least one external object, receive data from the at least one external object, select and transmit the data to at least one media processor and be operatively connected to the BUS; and
the at least one media processor configured to be operatively connected to the signal selector and the BUS, receive the data from the signal selector and perform media processing with the data.

2. The system of claim 1, wherein the at least one media processor is at least one of a video processor and an audio processor.

3. The system of claim 2, wherein the video processor is configured to receive a video data from the signal selector, and the audio processor is configured to receive a audio data from the signal selector.

4. The system of claim 1, wherein the signal selector is further configured to communicate with a plurality of the external objects in parallel via a plurality of ports.

5. The system of claim 1, wherein the signal selector is further configured to receive a signal and convert the signal into the data.

6. The system of claim 5, wherein the signal is at least one of an analog signal and a digital signal.

7. The system of claim 1, wherein the signal selector is further configured to transmit a signal to the at least one external object after converting the data into the signal.

8. The system of claim 1, wherein the data is selected and transmitted by the signal selector to the at least one main processor, and the at least one main processor transmits the data to the at least one media processor after processing the data.

9. The system of claim 1 further comprises a remote control circuit, wherein the remote control circuit is configured to communicate with a plurality of external peripheral devices in parallel via a plurality of ports and be operatively connected to at least one of the BUS and a multiplexer switch which is operatively connected to the BUS.

10. The system of claim 9, wherein the plurality of external peripheral devices is at least one of a remote controller, a keyboard, a mouse, an internet network, a digital camera, a printing machines, a portable computer and a portable phone.

11. The system of claim 9, wherein the remote control circuit is further configured to include a receiver/detector, wherein the receiver/detector receives and decodes video and audio data.

12. The system of claim 1 further comprises an audio control circuit, wherein the audio control circuit is configured to communicate with a plurality of external audio devices in parallel via a plurality of ports and be operatively connected to at least one of the BUS and the at least one media processor.

13. The system of claim 12, wherein the plurality of external audio devices is at least one of a microphone, a speaker, an audio systems and a television system.

14. The system of claim 1 further comprises an audio/video electronic control circuit, wherein the audio/video electronic control circuit is configured to communicate with a plurality of external devices in parallel via a plurality of ports of an access gateway and be operatively connected to at least one of the BUS and the at least one media processor.

15. The system of claim 14, wherein the plurality of external devices is at least one of a telephonic line, an internet appliance, a palmar appliance and mobile phone.

16. The system of claim 1 further comprises:
at least one tuner configured to receive a signal from the at least one external object; and
at least one demodulator configured to be operatively connected to the least one tuner, the BUS and the at least one media processor.

17. The system of claim 16, wherein the at least one demodulator demodulates the signal after receiving from the at least one tuner and transmit the demodulated signal to the at least one media processor.

18. The system of claim 16 further comprises an encoder/decoder, wherein the at least one demodulator is connected to the at least one media processor via the encoder/decoder, and the encoder/decoder is configured to encode or decode the demodulated signal before transmitting to the at least one media processor.

19. The system of claim 16, wherein the at least one demodulator is at least one of an analog demodulator or a digital demodulator.

20. The system of claim 1, wherein the at least one main processor manages and controls functional blocks of the system via the BUS.
